(19) United States
(12) Patent Application Publication
(10) Pub. No.: US 2025/0287194 A1
(43) Pub. Date: Sep. 11, 2025

(54) ROAMING DATA COLLECTION AMONG ACCESS POINTS

(71) Applicant: HEWLETT PACKARD ENTERPRISE DEVELOPMENT LP, Spring, TX (US)

(72) Inventors: Zhongguo Sun, Beijing (CN); Xiaoding Shang, Beijing (CN); Pengfei Jin, Beijing (CN); Haifeng Zhang, Beijing (CN)

(21) Appl. No.: 18/596,930

(22) Filed: Mar. 6, 2024

(51) Int. Cl. H04W 8/14; H04W 8/08; H04W 88/08

(52) U.S. Cl. CPC H04W 8/14; H04W 8/085; H04W 88/08

(57) ABSTRACT

In some examples, a first access point (AP) generates first potential target AP information identifying one or more APs to which an electronic device is able to roam from the first AP. The first AP sends the first potential target AP information to an aggregator AP that is associated with the first AP. The first AP receives, from the aggregator AP, a roaming monitoring instruction sent by the aggregator AP to one or more APs identified by second potential target AP information generated at a second AP, the roaming monitoring instruction specifying collection of roaming data for a given electronic device that has associated with the second AP.

### BACKGROUND

Electronic devices can connect to a wireless network to communicate with other endpoints. Examples of wireless networks include a wireless local area network (WLAN) (also referred to as a WI-FI network), cellular networks, or other types of wireless networks.

### BRIEF DESCRIPTION OF THE DRAWINGS

Some implementations of the present disclosure are described with respect to the following figures.

FIG. 1 is a block diagram of a wireless network including multiple access points (APs) and an electronic device that can roam between APs, according to some examples.

FIG. 2, FIG. 3, FIG. 4, and FIG. 5 are flow diagrams of processes according to some examples.

FIG. 6 is a block diagram of an AP according to some examples.

FIG. 7 is a flow diagram of a process according to some examples.

FIG. 8 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices can wirelessly connect to access points (APs) in wireless networks to communicate over the wireless networks. In some cases, a wireless network may include multiple APs, such as multiple APs in different physical locations. For example, in a building, different APs may be located on different floors of the building. More generally, in a large facility, an AP may not have sufficient range to cover the entire facility. Multiple APs can be deployed to provide adequate wireless coverage across the facility.

As an electronic device roams between different physical locations, the electronic device can transition between different APs. Initially, the electronic device is associated with a source AP while the electronic device is at a first physical location. When the electronic device moves to a transition area between the first physical location and a second physical location, a roaming process (also referred to as a “transition process”) is triggered that causes the electronic device to associate with a target AP at the second physical location. After the electronic device has associated with the second AP, the electronic device can disassociate from the first AP.

In some examples, roaming data can be collected in response to electronic devices transitioning between different APs. Roaming data can include data plane information and/or control plane information. The roaming data can be sent to a remote AP control system for processing of the roaming data. The processing of the roaming data can include any or some combination of the following: logging the roaming data, analyzing the roaming data to identify any issues associated with roaming between different APs, or other types of processing.

The total amount of roaming data can be large if there are a large number of electronic devices and APs in a wireless network, which can place a heavy processing load on the remote AP control system associated with processing the roaming data. As a result, the remote AP control system may have to be configured with sufficient processing capacity to handle a large volume of roaming data, which can increase the cost of the remote AP control system.

Moreover, when there are a large number of electronic devices, it can be difficult to predict which APs the electronic devices will roam to as the electronic devices move around. In some examples, roaming data from a source AP and a target AP is aggregated when an electronic device roams from the source AP to the target AP. Processing of the aggregated roaming data is performed to identify any issues associated with the transition of the electronic device between the source AP and the target AP. However, when there are a large number of APs, it can be challenging to determine which roaming data from different APs is to be aggregated due to unpredictable movements of electronic devices among the large number of APs, especially if there is a dense arrangement of APs located relative close to one another.

In accordance with some implementations of the present disclosure, an AP roaming management system is able to define a hierarchy of APs including aggregator APs that are “parents” of APs involved in roaming processes. Additionally, the AP roaming management system is able to generate potential target AP information that identifies one or more APs that are potential targets for roaming of an electronic device from a source AP. The AP roaming management system can be made up of APs and associated systems (discussed further below).

Using the potential target AP information for the source AP, an aggregator AP is able to distribute a roaming monitoring instruction to the one or more potential target APs identified by the potential target AP information. The roaming monitoring instruction specifies what roaming data is to be collected by a target AP identified in the potential target AP information if the electronic device were to actually transition to the target AP from the source AP. There may be a large amount of roaming data, and the roaming monitoring instruction can specify a subset of the roaming data to be collected.

By distributing the roaming monitoring instruction to each potential target AP identified by the potential target AP information, the potential target AP may ready itself to begin the process of collecting roaming data for the electronic device. Thus, when the electronic device actually roams to the target AP, the target AP can quickly collect roaming data in accordance with the roaming monitoring instruction.

The roaming process to transition the electronic device between APs can occur relatively quickly, such as on the order of less than 100 milliseconds (ms) or some other relatively short duration. As a result, a target AP to which the electronic device has transitioned should react quickly in collecting roaming data and sending the roaming data to the aggregator AP. The roaming monitoring instruction distributed to potential target APs ahead of time allows a target AP to more quickly react in collecting the subset of roaming data specified by the roaming monitoring instruction once the electronic device has actually transitioned to the target AP.

Based on the roaming monitoring instruction, the target AP to which the electronic device has roamed from the source AP collects first roaming data and sends the first roaming data to the aggregator AP. The aggregator AP also receives second roaming data from the source AP, which was sent by the source AP in response to the electronic device roaming from the source AP to the target AP. The aggregator AP aggregates the first and second roaming data to produce aggregated roaming data. The aggregator AP also applies selected processing to the aggregated roaming data and sends the processed aggregated roaming data to a remote AP control system for analysis.

By applying the selected processing at the aggregator AP, the selected processing would not have to be performed at the remote AP control system, which reduces the processing load on the remote control system. If there are multiple aggregator APs identified in the wireless network, the selected processing performed at the multiple aggregator APs can substantially reduce the amount of work that has to be performed at the remote AP control system. As a result, the remote AP control system can be configured with fewer resources (e.g., processing resources and storage resources), which can reduce the cost of the remote AP control system. Also, the remote AP control system can more timely perform its analysis of the processed aggregated roaming data to identify and react to any issues that may be present in roaming processes between APs.

The issues that are identified can prevent successful roaming of electronic devices between some APs. By being able to efficiently identify such issues, the relevant technology is improved by resolving such issues so that electronic devices may more reliably roam between APs. The resolution of the issues in some cases may be automatically performed by the remote AP control system.

Examples of roaming data can include any or some combination of control plane information or data plane information. Control plane information can include any or some combination of the following: authentication, authorization, and accounting (AAA) information, control information (such as control messages or content in control messages) used to set up sessions of electronic devices, configuration information, information that relates to managing communications of electronic devices with APs, or other control information. AAA information includes information associated with authenticating electronic devices and authorizing activities of the electronic devices. The AAA information may also include accounting information that pertains to billing for services used by electronic devices.

Data plane information may include any or some combination of the following: forwarding session information, network address information (including Internet Protocol (IP) addresses and/or Media Access Control (MAC) addresses, for example), information relating to virtual networks (e.g., virtual local area networks (VLANs)), or any other information relating to exchange of data between electronic devices and accessed resources (resources accessed by the electronic devices, where the resources may include programs, machines, storage, or other resources). Forwarding session information may include any or some combination of the following: information from headers of packets communicated between electronic devices and accessed resources, information extracted from a deep packet inspection of packets, or other information associated with packet communications. An example of information extracted from a header of a packet can include a 5-tuple, including a source IP address, a source port, a destination IP address, a destination port, and a transport protocol. An example of information extracted from a deep packet inspection of a packet can include an identifier of an entity associated with the communication of data in the packet, where the entity can include an application program, a hardware component, a user, or any other entity.

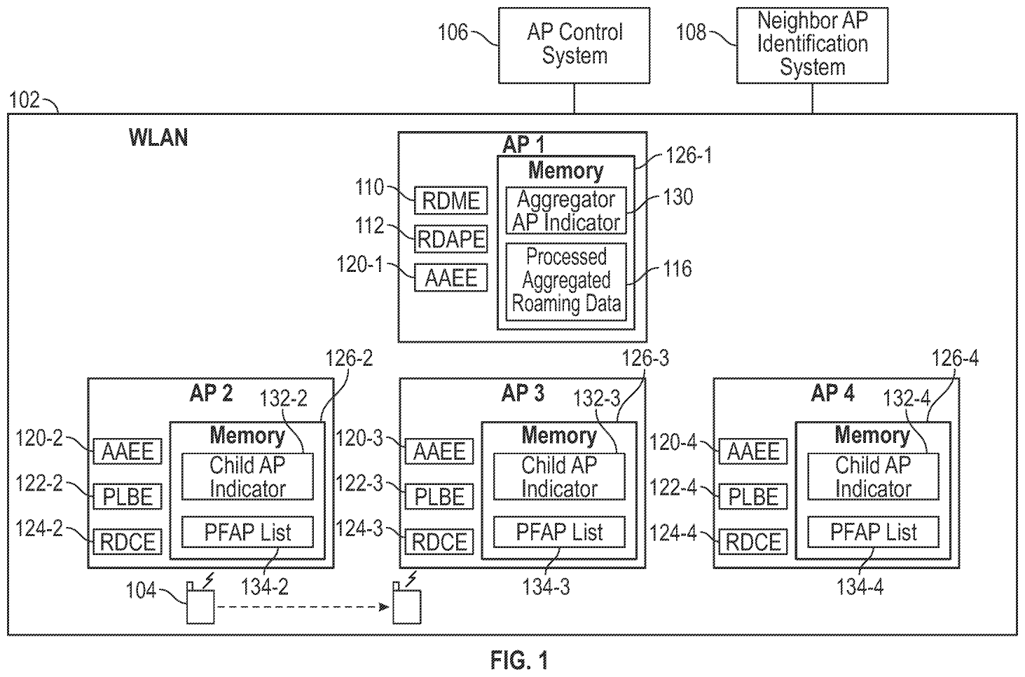

FIG. 1 is a block diagram of an example network arrangement including a wireless network, such as a WLAN 102, that includes various APs. Each AP has a respective coverage area in which electronic devices within the coverage area are able to communicate with the AP. The APs depicted in the example of FIG. 1 include AP 1, AP 2, AP 3, and AP 4. Although four APs are depicted in FIG. 1, in other examples, the WLAN 102 can include a different quantity of APs.

FIG. 1 also depicts an electronic device 104 that is able to physically move around. Examples of electronic device can include any or some combination of the following: notebook computers, tablet computers, smartphones, game appliances, vehicles, or any other electronic devices that can physically move such that they can change association with different APs.

In the example of FIG. 1, the electronic device 104 is initially associated with AP 2. Note that there may be multiple electronic devices in the WLAN 102. An electronic device being associated with an AP can refer to the electronic device establishing a wireless connection with the AP and being able to communicate with the AP over the wireless connection. For example, the WLAN 102 can operate according to the Institute of Electrical and Electronics Engineers (IEEE) 802.11 Standard, which defines various states of an electronic device. The states include an associated state in which the electronic device has established an association with an AP. The states also include an authenticated state in which the electronic device has been authenticated by the AP. The following are the possible IEEE 802.11 states: not authenticated and not associated, authenticated and not associated, and authenticated and associated.

Although reference is made to IEEE 802.11 as an example of a standard governing operations of the electronic device 104 and the APs of FIG. 1, in other examples, the electronic device 104 and the APs can operate according to other protocols.

As used here, an “access point” or “AP” can refer to a network node that operates according to IEEE 802.11. In other examples, an AP can be network node that operates according to another protocol. An AP can also refer to a cellular network node, such as a base station, or any other network node that is able to establish wireless network connectivity with electronic devices.

Each of the APs can include various engines. As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

As discussed below, an AP can be designated as an aggregator AP or as a child AP, where the child AP is a child of an aggregator AP. The aggregator AP is also considered a parent of the child AP. Note that any of AP 1, AP 2, AP 3, and AP 4 can be designated as an aggregator AP or a child AP. In the example of FIG. 1, AP 1 is designated as the aggregator AP, while AP 2, AP 3, and AP 4 are designated as child APs that are children of the aggregator AP. There may be multiple aggregator APs associated with respective collections of child APs.

In further examples, the WLAN 102 can include multiple aggregator APs with their respective collections of child APs. Also, although FIG. 1 shows just one WLAN 102, it is noted that a network arrangement can include multiple WLANs (or more generally, multiple wireless networks) with their respective APs. Techniques or mechanisms according to some implementations of the present disclosure can be applied in the context of multiple wireless networks.

In the example of FIG. 1, the aggregator AP includes a roaming data management engine (RDME) 110, a roaming data aggregation and processing engine (RDAPE) 112, and an aggregator AP election engine (AAEE) 120-1. AP 2 includes an aggregator AP election engine 120-2, a potential foreign AP (PFAP) list building engine (PLBE) 122-2 and a roaming data collection engine (RDCE) 124-2. AP 3 similarly includes an aggregator AP election engine 120-3, a PFAP list building engine 122-3, and a roaming data collection engine 124-3; and AP 4 similarly includes an aggregator AP election engine 120-4, a PFAP list building engine 122-4, and a roaming data collection engine 124-4.

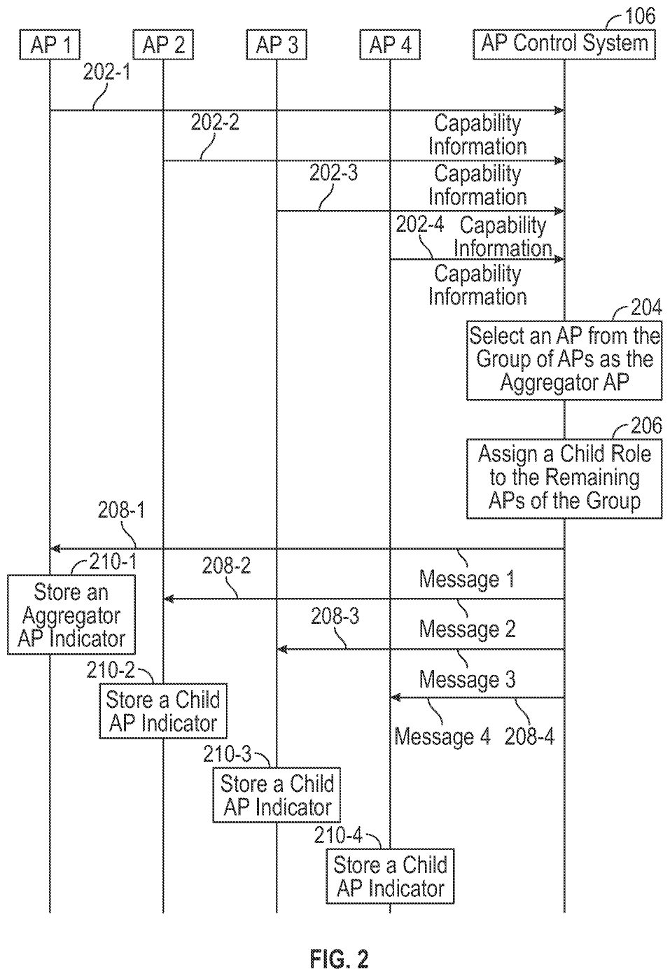

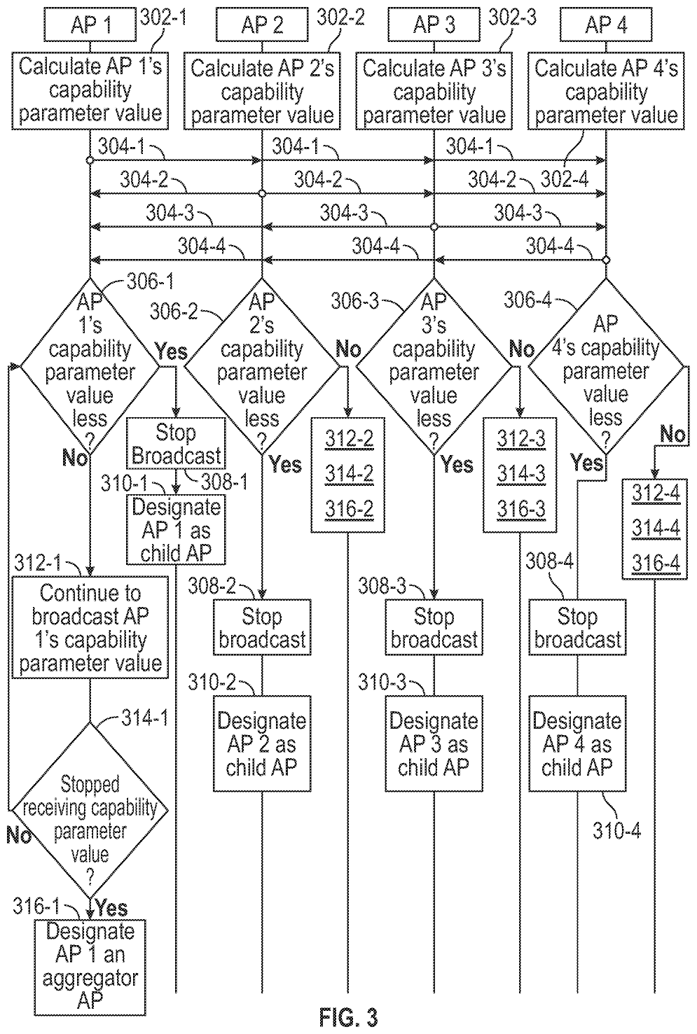

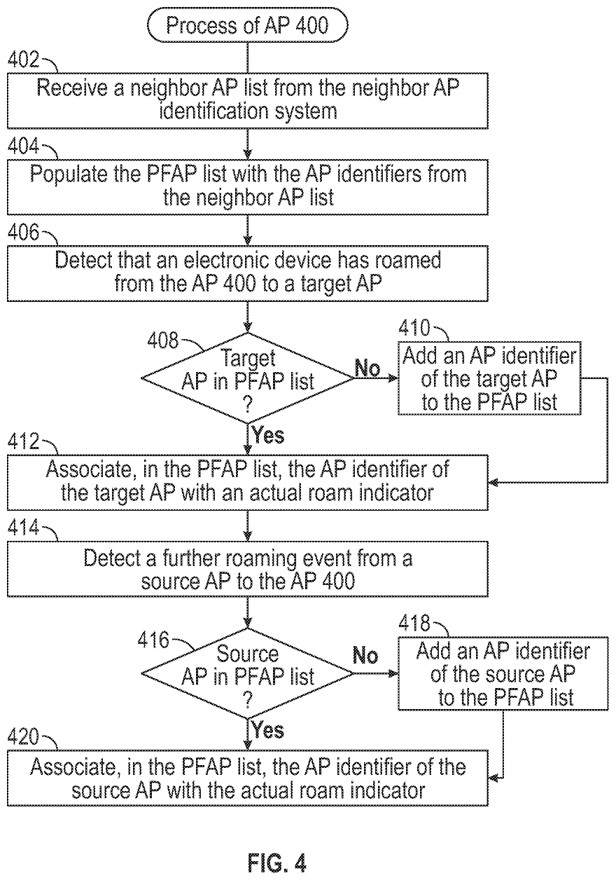

The functionalities of the various engines shown in FIG. 1 are discussed further below in connection with FIGS. 2-5.

The network arrangement of FIG. 1 also includes an AP control system 106 and a neighbor AP identification system 108. Each of the AP control system 106 and the neighbor AP identification system 108 can be implemented using one or more computers. Although depicted as two separate systems, the AP control system and the neighbor AP identification system 108 may be integrated into one system.

Note that each of AP 2, AP 3, and AP 4 can also include an aggregation control engine and a roaming data aggregation and processing engine (for use when AP 2, AP 3, or AP 4 are designated as an aggregator AP). Similarly, AP 1 can also include an a PFAP list building engine and a roaming data collection engine (for use when AP 1 is designated a child AP).

The designation of which AP of the WLAN 102 is the aggregator AP can be performed in one of several different ways. In an example, a human administrator of the WLAN 102 can specify which of the APs is the aggregator AP. For example, the human administrator can use an administrator device (e.g., a desktop computer, a notebook computer, a tablet computer, a smartphone, or any other electronic device with a user interface) to select an AP of the WLAN 102 as the aggregator AP.

In another example, the AP control system 106 can select an AP as the aggregator AP. In a further example, the APs can participate in an election process to elect an aggregator AP.

FIG. 2 is a flow diagram of an example process of the AP control system 106 to select an aggregator AP from among a group of APs, such as a group including AP 1, AP 2, AP 3, and AP 4. In different examples, the tasks in the process of FIG. 2 may be performed in a different order, additional tasks may be added, and/or some tasks may be omitted.

The group of APs (including AP 1, AP 2, AP 3, and AP 4) can send (at 202-1, 202-2, 202-3, and 202-4) their respective capability information to the AP control system 106. Examples of capability information can include any or some combination of the following: resource utilization such as a processing resource utilization (e.g., utilization of one or more hardware processors of the AP), a memory utilization (e.g., an indication of how much of the overall memory capacity of the AP is consumed), communication resource utilization (e.g., a utilization of communication resources), or a utilization of another resource; network status information (e.g., information pertaining to whether any issues impact communications by slowing down communications or causing errors); or other capability information.

Based on the capability information received from the APs, the AP control system 106 selects (at 204) one of the APs of the group as the aggregator AP, and assigns (at 206) a child role to the remaining APs of the group. In the example of FIG. 2, the AP control system 106 selects AP 1 as the aggregator AP, and selects AP 2, AP 3, and AP 4 as child APs.

In selecting an AP as an aggregator AP, the AP control system 106 may favor: (1) an AP indicated by the capability information as having the most available capacity (e.g., most available processing capacity, most available memory capacity, and/or most available communication capacity) from among the APs of the group, and/or (2) an AP associated with less communication issues as indicated by the network status information. An AP with less communication issues is able to communicate at a higher data rate and/or may experience less errors in data communications. In further examples, the AP control system 106 may consider additional or alternative factors in selecting an aggregator AP from a group of APs.

The AP control system sends (at 208-1) a message (Message 1) to AP 1 indicating that AP 1 is designated the aggregator AP. A “message” can refer to a packet, an information element in a packet, a signal, or any other indicator. In response to Message 1, AP 1 stores (at 210-1) an aggregator AP indicator 130 in a memory 126-1 of AP 1 (FIG. 1). The aggregator AP indicator 130 can be an aggregator/child flag (including one or more bits) that is set to a first value (e.g., 1) to indicate AP 1 is the aggregator AP. The aggregator/child flag if set to a different second value (e.g., 0) indicates that AP 1 is a child AP.

The AP control system sends (at 208-2) a message (Message 2) to AP 2 indicating that AP 2 is designated a child AP. In response to Message 2, AP 2 stores (at 210-2) a child AP indicator 132-2 in a memory 126-2 of AP 2 (FIG. 1), such as by setting an aggregator/child flag to the second value (e.g., 0). Similarly, the AP control system sends (at 208-3) a message (Message 3) to AP 3 indicating that AP 3 is designated a child AP. In response to Message 3, AP 3 stores (at 210-3) a child AP indicator 132-3 in a memory 126-3 of AP 2 (FIG. 1). The AP control system sends (at 208-4) a message (Message 4) to AP 4 indicating that AP 4 is designated a child AP. In response to Message 4, AP 4 stores (at 210-4) a child AP indicator 132-4 in a memory 126-4 of AP 4 (FIG. 1).

FIG. 3 shows an example of an election process performed by a group of APs in selecting an aggregator AP. Instead of the AP control system 106 selecting an aggregator AP, the APs of the group of APs can elect one of the APs as the aggregator AP. In different examples, the tasks in the process of FIG. 3 may be performed in a different order, additional tasks may be added, and/or some tasks may be omitted.

As shown in FIG. 3, the aggregator AP election engine of each AP calculates a capability parameter value based on capability information of the AP. More specifically, the aggregator AP election engine 120-1 of AP 1 calculates (at 302-1) AP 1's capability parameter value, the aggregator AP election engine 120-2 of AP 2 calculates (at 302-2) AP 2's capability parameter value, the aggregator AP election engine 120-3 of AP 3 calculates (at 302-3) AP 3's capability parameter value, and the aggregator AP election engine 120-4 of AP 4 calculates (at 302-4) AP 4's capability parameter value. A “capability parameter value” can refer to a single value or a group of values that indicates a respective capability (including, as examples, how much processing resource is available, how much memory is available, a capacity of a communication, a network status, etc.) of the AP. The capability parameter value may also indicate a network status of the AP, such as whether the AP is experiencing slow network communications or fast network communications.

Each AP broadcasts its capability parameter value to the other APs of the group. AP 1 broadcasts (at 304-1) its capability parameter value to AP 2, AP 3, and AP 4; AP 2 broadcasts (at 304-2) its capability parameter value to AP 1, AP 3, and AP 4; AP 3 broadcasts (at 304-3) its capability parameter value to AP 1, AP 2, and AP 4; and AP 4 broadcasts (at 304-4) its capability parameter value to AP 1, AP 2, and AP 3.

The calculation of the capability parameter value and the broadcast of the capability parameter value by each AP is iterated, such as periodically or in response to other events. The capability parameter value of an AP may change as conditions (e.g., utilization of a resource or communication issues arising or being solved) of the AP change.

A given AP receiving capability parameter values from other APs makes a determination of whether the given AP or another AP has a greater capability. In some examples, it is assumed that a higher capability parameter value indicates a greater capability of an AP as compared to a lower capability parameter value. An AP has a “greater capability” if the AP has more available resources and/or the AP is experiencing less communication issues. In some examples, the given AP continues to broadcast its capability parameter value until the given AP receives a capability parameter value of another AP that is greater than the capability parameter value of the given AP.

As shown in FIG. 1, the aggregator AP election engine 120-1 of AP 1 determines (at 306-1) whether AP 1's capability parameter value is less than each of the capability parameter values from other APs of the group. If so, the aggregator AP election engine 120-1 makes a determination (at 308-1) to stop broadcasting AP 1's capability parameter value, and the aggregator AP election engine 120-1 designates (at 310-1) AP 1 as a child AP. If the aggregator AP election engine 120-1 determines (at 306-1) that AP 1's capability parameter value is not less than any capability parameter value from another AP, the aggregator AP election engine 120-1 continues to broadcast (at 312-1) AP 1's capability parameter value.

The aggregator AP election engine 120-1 determines (at 314-1) whether AP 1 has stopped receiving broadcasts of capability parameter values from other APs for more a threshold time duration. For example, the aggregator AP election engine 120-1 can start a timer to count the threshold time duration. If the aggregator AP election engine 120-1 receives a capability parameter value from any other AP, the timer is reset and starts counting again, and the aggregator AP election engine 120-1 proceeds to task 306-1. However, if the timer expires, then that indicates no capability parameter value has been received from any other AP of the group for more than the threshold time duration.

If the aggregator AP election engine 120-1 determines (at 314-1) that the AP 1 has stopped receiving broadcasts of capability parameter values from other APs for more the threshold time duration (e.g., the timer has expired), the aggregator AP election engine 120-1 designates (at 316-1) AP 1 as the aggregator AP, such as by storing the aggregator AP indicator 130 in the memory 126-1 of AP 1 (FIG. 1) (e.g., setting AP 1's aggregator/child flag to the first value). In the present discussed example, it is assumed that AP 1 is designated the aggregator AP.

If the aggregator AP election engine 120-1 determines (at 314-1) that the AP 1 has not stopped receiving broadcasts of capability parameter values from other APs, the aggregator AP election engine 120-1 returns to task 306-1.

The other APs (AP 2, AP3, and AP 4) perform similar tasks. The aggregator AP election engine 120-2 of AP 2 determines (at 306-2) whether AP 2's capability parameter value is less than each of the capability parameter values from other APs of the group. If so, the aggregator AP election engine 120-2 makes a determination (at 308-2) to stop broadcasting AP 2's capability parameter value, and the aggregator AP election engine 120-2 designates (at 310-2) AP 2 as a child AP. In the present discussed example, it is assumed that AP 2 is designated a child AP.

As a result, the aggregator AP election engine 120-2 stores the child AP indicator 132-2 in the memory 126-2 of AP 2 (FIG. 1), such as by setting AP 2's aggregator/child flag to the second value (e.g., 0).

If the aggregator AP election engine 120-2 determines (at 306-2) that AP 2's capability parameter value is not less than each of the capability parameter values from other APs of the group, the aggregator AP election engine 120-2 performs tasks 312-2, 314-2, and 316-2 that are similar to respective tasks 312-1, 314-1, and 316-1.

The aggregator AP election engine 120-3 of AP 3 determines (at 306-3) whether AP 3's capability parameter value is less than each of the capability parameter values from other APs of the group. If so, the aggregator AP election engine 120-3 makes a determination (at 308-3) to stop broadcasting AP 3's capability parameter value, and the aggregator AP election engine 120-3 designates (at 310-3) AP 3 as a child AP. In the present discussed example, it is assumed that AP 3 is designated a child AP. As a result, the aggregator AP election engine 120-3 stores the child AP indicator 132-3 in the memory 126-3 of AP 3 (FIG. 1), such as by setting AP 3's aggregator/child flag to the second value (e.g., 0).

If the aggregator AP election engine 120-3 determines (at 306-3) that AP 3's capability parameter value is not less than each of the capability parameter values from other APs of the group, the aggregator AP election engine 120-3 performs tasks 312-3, 314-3, and 316-3 that are similar to respective tasks 312-1, 314-1, and 316-1.

The aggregator AP election engine 120-4 of AP 4 determines (at 306-4) whether AP 4's capability parameter value is less than each of the capability parameter values from other APs of the group. If so, the aggregator AP election engine 120-4 makes a determination (at 308-4) to stop broadcasting AP 4's capability parameter value, and the aggregator AP election engine 120-4 designates (at 310-4) AP 4 as a child AP. In the present discussed example, it is assumed that AP 4 is designated a child AP. As a result, the aggregator AP election engine 120-4 stores the child AP indicator 132-4 in the memory 126-4 of AP 4 (FIG. 1), such as by setting AP 4's aggregator/child flag to the second value (e.g., 0).

If the aggregator AP election engine 120-4 determines (at 306-4) that AP 4's capability parameter value is not less than each of the capability parameter values from other APs of the group, the aggregator AP election engine 120-4 performs tasks 312-4, 314-4, and 316-4 that are similar to respective tasks 312-1, 314-1, and 316-1.

FIG. 4 is a flow diagram of a process of building potential foreign AP (PFAP) lists by child APs (which in the example are AP 2, AP 3, and AP 4). Each child AP generates its respective PFAP list, which is an example of potential target AP information that identifies one or more potential target APs to which electronic devices can roam from the child AP (source AP). The process of FIG. 4 is performed by an AP 400, which can be any child AP (e.g., AP 2, AP 3, or AP 4). In different examples, the tasks in the process of FIG. 4 may be performed in a different order, additional tasks may be added, and/or some tasks may be omitted.

The AP 400 receives (at 402) a neighbor AP list from the neighbor AP identification system 108. In some examples, the neighbor AP identification system 108 includes a radio resource management service that monitors radio frequency signals (e.g., beacons or other signals) transmitted by APs, and based on the monitored radio signals, the neighbor AP identification system 108 identifies which APs are proximate other APs (proximate APs are identified as neighbor APs). The neighbor AP list received by the AP 400 from the neighbor AP identification system 108 includes AP identifiers of APs that are neighbors of the AP 400, as determined by the neighbor AP identification system 108.

The PFAP list building engine (e.g., one of 122-2, 122-3, and 122-4 in FIG. 1) populates (at 404) the PFAP list with the AP identifiers of the neighbor APs included in the neighbor AP list. In other words, the PFAP list of the AP 400 is initially set based on the neighbor AP list.

Subsequently, the PFAP list building engine can update the PFAP list based on actual roaming events of electronic devices. In some cases, the neighbor AP list may be updated by the neighbor AP identification system 108, in which case the PFAP list building engine can update the PFAP list with the updated neighbor AP list.

The PFAP list building engine detects (at 406) that an electronic device has roamed from the AP 400 (the source AP) to a target AP. In response to detecting the roaming event, the PFAP list building engine determines (at 408) whether the target AP is identified in the PFAP list. If the target AP is not identified in the PFAP list, the PFAP list building engine adds (at 410) an AP identifier of the target AP to the PFAP list. Additionally, the PFAP list building engine associates (at 412), in the PFAP list, the identifier of the target AP with an actual roam indicator to indicate that the target AP is an AP to which an electronic device has roamed from the AP 400. The actual roam indicator can be in the form of a flag that is set to a first value (e.g., 1). If the flag is set to a second value (e.g., 0), then that indicates an associated AP identified in the PFAP list is not an AP to which an electronic device has roamed from the AP 400.

In response to determining (at 408) that the target AP is already identified in the PFAP list, the PFAP list building engine associates (at 412), in the PFAP list, the identifier of the target AP with the actual roam indicator.

Any AP associated with the actual roam indicator in the PFAP list is less likely to be removed from the PFAP list when the PFAP list building engine performs an update of the PFAP list. Any AP not associated with the actual roam indicator in the PFAP list may more likely be removed from the PFAP list when the PFAP list building engine performs an update of the PFAP list. Removing an AP from the PFAP list refers to removing an AP identifier of the AP from the PFAP list.

Note that the target AP would also update its PFAP list based on the same roaming event detected by AP 400. The target AP updates the target AP's PFAP list to add an AP identifier of the AP 400 (the source AP) from which an electronic device has roamed to the target AP. The target AP also associates the actual roam indicator with the AP identifier of the AP 400 added to the target AP's PFAP list.

The AP 400 detects (at 414) a further roaming event relating to an electronic device roaming from a source AP to the AP 400 (the AP 400 is the target AP). In response to the further roaming event, the PFAP list building engine of the AP 400 determines (at 416) whether the source AP is already identified in the PFAP list. If not, the PFAP list building engine adds (at 418) an AP identifier of the source AP to the PFAP list, and associates (at 420), in the PFAP list, the AP identifier of the source AP with the actual roam indicator. If the source AP is already identified in the PFAP list, the PFAP list building engine associates (at 420) the actual roam indicator with the source AP in the PFAP list.

FIG. 1 shows a PFAP list 134-2 added by PFAP list building engine 122-2 to the memory 126-2 of AP 2, a PFAP list 134-3 added by PFAP list building engine 122-3 to the memory 126-3 of AP 3, and a PFAP list 134-4 added by PFAP list building engine 122-4 to the memory 126-4 of AP 4.

In some examples, before the PFAP list building engine adds (at 410 or 418) an AP identifier to the PFAP list, the PFAP list building engine can determine whether the quantity of AP identifiers in the PFAP list is equal to a maximum quantity of AP identifiers. The maximum quantity of AP identifiers is set for the PFAP list to prevent the PFAP list from becoming too long and unwieldy. If the quantity of AP identifiers in the PFAP list is equal to a maximum quantity of AP identifiers, the PFAP list building engine applies aging to the PFAP list by removing an AP identifier from the PFAP list to allow the addition of a new AP identifier.

In performing aging of the PFAP list, the PFAP list building engine first determines whether any AP identifiers not associated with the actual roam indicator is present in the PFAP list. If so, the PFAP list building engine can remove the oldest of the AP identifiers not associated with the actual roam indicator from the PFAP list. Each AP identifier in the PFAP list may be associated with a timestamp indicating when the AP identifier was added to the PFAP list. The oldest AP identifier is the one associated with the earliest timestamp in the PFAP list.

In some examples, the actual roam indicator associated with each AP identifier in the PFAP list may be associated with a lifetime value, which specifies the length of time for which the actual roam indicator is valid. The lifetime value may be in the form of a lifetime timer that starts running (incrementing or decrementing) when the respective actual roam indicator is added to the PFAP list. If an electronic device roams to an AP identified by the AP identifier associated with the actual roam indicator, the lifetime timer is reset. However, if no electronic device roams to the AP identified by the AP identifier associated with the actual roam indicator, the lifetime timer continues to run until the lifetime timer expires. When the lifetime timer expires, the actual roam indicator can be cleared such that the AP identifier is no longer associated with the actual roam indicator.

In some examples, the lifetime timer can be initially set with a default time value (e.g., 1 week or a different time value). When set to the default time value, the lifetime timer runs for a length of time corresponding to the default time value at which point the lifetime timer expires.

In some cases, the lifetime timer can be adjusted with an adaptive time value that can dynamically change based on detected conditions. For example, if the PFAP list building engine detects that the roaming frequency of electronic devices in the WLAN 102 is relatively high (e.g., greater than a first frequency threshold), then the PFAP list building engine can update the lifetime timer for each AP identifier of the PFAP list to a lower time value that is less than the default time value. However, if the PFAP list building engine detects that the roaming frequency of electronic devices in the WLAN 102 is relatively low (e.g., less than a second frequency threshold that may be the same as or different from the first frequency threshold), then the PFAP list building engine can update the lifetime timer for each AP identifier of the PFAP list to a higher time value that is greater than the default time value.

In some cases, it may be possible for all AP identifiers in the PFAP list to be associated with actual roam indicators (i.e., the lifetime timers associated with all actual roam indicators in the PFAP list have not yet expired). In such examples, the PFAP list building engine applies aging to the PFAP list by removing the oldest AP identifier associated with the actual roam indicator from the PFAP list to allow the addition of a new AP identifier.

FIG. 5 is a flow diagram of a process of collecting and aggregating roaming data. In different examples, the tasks in the process of FIG. 5 may be performed in a different order, additional tasks may be added, and/or some tasks may be omitted.

A source AP 500 associates (at 506) with an electronic device. In response to the association, the source AP 500 sends (at 508) a network address of the electronic device and the source AP's PFAP list to an aggregator AP 502 for the source AP 500. The source AP's PFAP list may identify target APs 504-1 and 504-2.

Note that in other examples the source AP's PFAP list can identify less than two target APs or more than two target APs.

In response to receiving the network address of the electronic device and the source AP's PFAP list, the roaming data management engine (e.g., 110 in FIG. 1) in the aggregator AP 502 distributes (at 510-1, 510-2) roaming monitoring instructions and the network address (e.g., a MAC address) of the electronic device to the target APs 504-1 and 504-2 identified in the source AP's PFAP list. The roaming data collection engine of the aggregator AP can also distribute (at 512) a roaming monitoring instruction to the source AP 500. A roaming monitoring instruction can be in the form of a command or a message. The roaming monitoring instruction may be preconfigured by a network administrator or another entity. The roaming monitoring instruction can specify a subset of roaming data to be collected in response to a roaming event.

In response to the roaming monitoring instructions, the target AP 504-1 starts monitoring (at 514-1) for a roaming event involving the electronic device (identified by the network address), and similarly, the target AP 504-2 starts monitoring (at 514-2) for a roaming event involving the electronic device.

In the example, it is assumed that the electronic device has roamed from the source AP 500 to the target AP 504-2. Based on the roaming event, the roaming data collection engine (e.g., any of 124-2, 124-3, or 124-4 in FIG. 1) in the source AP 500 collects (at 516) the subset of roaming data specified by the roaming monitoring instruction received from the aggregator AP 502. The target AP 504-2 also collects (at 518) the subset of roaming data specified by the roaming monitoring instruction received from the aggregator AP 502. The target AP 504-1 does not collect roaming data because the electronic device identified by the network address did not roam to the target AP 504-1.

The source AP 500 sends (at 520) source roaming data collected by the source AP 500 to the aggregator AP 502, and the target AP 504-2 sends (at 522) target roaming data collected by the target AP 504-2 to the aggregator AP 502.

The roaming data aggregation and processing engine (e.g., 112 in FIG. 1) of the aggregator AP 502 aggregates (at 524) the source roaming data and the target roaming data to produce aggregated roaming data that includes roaming data collected by the source AP 500 and roaming data collected by the target AP 504-2.

The roaming data aggregation and processing engine also applies processing (at 526) of the aggregated roaming data. The applied processing can include removing redundant data (e.g., redundant 5-tuples, etc.) from the aggregated roaming data. The applied processing may also include converting the format of the aggregated roaming data from a first format to a second format. Other types of processing can be applied in other examples.

After the processing applied by the roaming data aggregation and processing engine of the aggregator AP 502 to produce processed aggregated roaming data (e.g., 136 in FIG. 1), the aggregator AP 502 sends (at 528) the processed aggregated roaming data to the AP control system 106, which can apply analysis on the processed aggregated roaming data, such as to detect any issues (faults, errors, etc.) associated with the roaming of the electronic device.

Using techniques or mechanisms according to some examples of the present disclosure, an efficient way of collecting roaming data associated with roaming of electronic devices among APs is provided. The collected roaming data can be aggregated and processed at an aggregator AP to reduce processing load on a remote AP control system such as the AP control system 106.

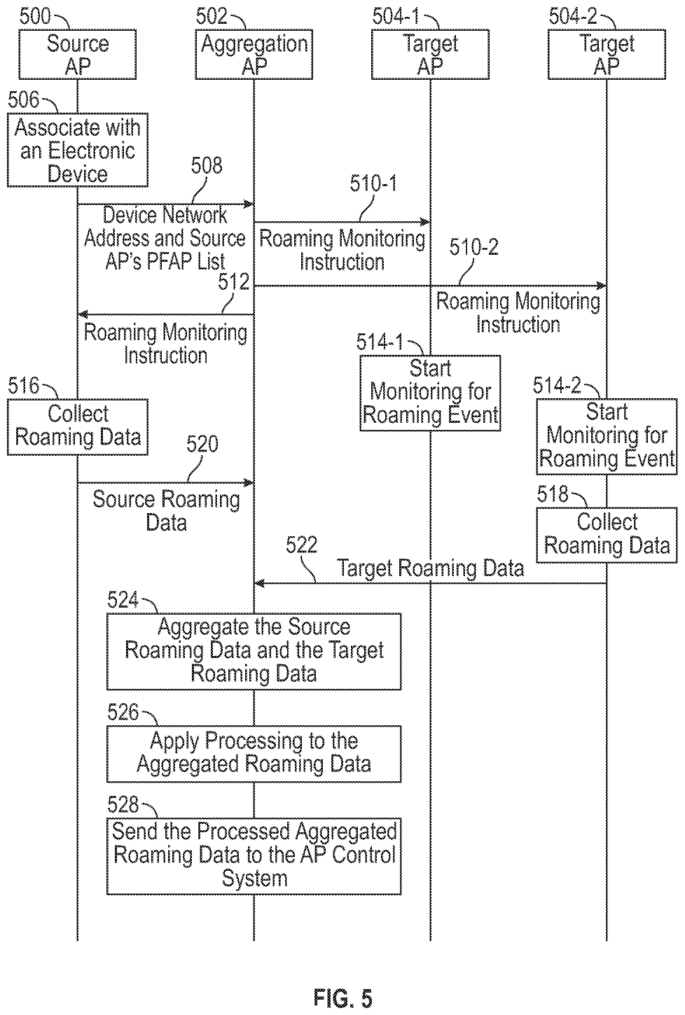

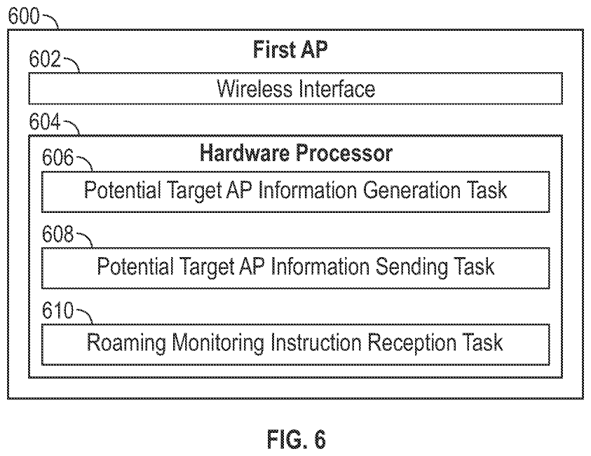

FIG. 6 is a block diagram of a first AP 600 according to some examples. The first AP 600 can be a child AP, such as AP 2, 3, or 4 in FIG. 1. The first AP 600 includes a wireless interface 602 to communicate wirelessly with electronic devices. The wireless interface 602 can include a signal transceiver to transmit and receive wireless signals. The wireless interface 602 can also include protocol layers that manage protocols for communications over the WLAN 102.

The first AP 600 includes a hardware processor 604 (or multiple hardware processors). A hardware processor can include a microprocessor, a core of a multi-core microprocessor, a microcontroller, a programmable integrated circuit, a programmable gate array, or another hardware processing circuit.

The hardware processor 604 can perform various tasks, such as based on machine-readable instructions executed by the hardware processor 604. A hardware processor performing a task can refer to a single hardware processor performing the task or multiple hardware processors performing the task.

The tasks of the hardware processor 604 include a potential target AP information generation task 606 to generate first potential target AP information identifying one or more target APs to which an electronic device is able to roam from the first AP. An example of the first potential target AP information is a PFAP list.

The tasks of the hardware processor 604 include a potential target AP information sending task 608 to send the first potential target AP information to an aggregator AP that is associated with the first AP.

The tasks of the hardware processor 604 include a roaming monitoring instruction reception task 610 to receive, from the aggregator AP, a roaming monitoring instruction sent by the aggregator AP to one or more APs identified by second potential target AP information generated at a second AP. The roaming monitoring instruction specifies collection of roaming data for a given electronic device that has associated with the second AP. The first AP is a potential target AP to which the given electronic device may transition from the second AP.

In some examples, the hardware processor 604 detects that the given electronic device has roamed from the second AP to the first AP. In response to the detecting, the hardware processor 604 collects, based on the roaming monitoring instruction, the roaming data for the given electronic device at the first AP. The hardware processor 604 sends the collected roaming data to the aggregator AP for aggregation of the collected roaming data with further roaming data for the given electronic device received by the aggregator AP from the second AP.

In some examples, the hardware processor 604 detects that the given electronic device has roamed from the first AP to a third AP. The hardware processor 604 determines that the third AP is not identified by the first potential target AP information, and based on determining that the third AP is not identified by the first potential target AP information, the hardware processor 604 updates the first potential target AP information to identify the third AP.

In some examples, the hardware processor 604 receives, from a service (e.g., a service of the neighbor AP identification system 108 of FIG. 1), first neighbor AP information (e.g., a neighbor AP list) derived from RF information (e.g., RF signals) associated with a plurality of APs. The first neighbor AP information identifies neighbor APs of the first AP. The generating of the potential target AP information includes adding, to the first potential target AP information, identifiers of the neighbor APs from the first neighbor AP information, and adding an identifier of a further AP based on an actual roaming event involving the further AP.

In some examples, the generating of the first potential target AP information includes associating an actual roaming indicator with the identifier of the further AP, where the actual roaming indicator indicates that the identifier of the further AP is related to the actual roaming event.

In some examples, the hardware processor 604 receives, from the service, updated neighbor AP information identifying updated neighbor APs of the first AP. The hardware processor 604 updates, based on the updated neighbor AP information, the first potential target AP information to include the identifiers of the updated neighbor APs.

In some examples, the hardware processor 604 updates the first potential target AP information by removing an identifier of an AP that is in the first neighbor AP information and adding an identifier of another AP. The identifier removed can be the oldest identifier in the first potential target AP information.

In some examples, the updating of the first potential target AP information includes preventing a removal of the identifier of the further AP from the first potential target AP information based on presence of the actual roaming indicator. The hardware processor 604 favors the removal of an identifier of an AP not associated with the actual roaming indicator.

In some examples, the actual roaming indicator has an expiration time, such as based on a lifetime timer as discussed above. After the expiration time has elapsed (e.g., the lifetime timer has expired), the hardware processor 406 clears the actual roaming indicator.

In some examples, the hardware processor 406 resets the expiration time based on detecting an electronic device roaming from the first AP to the further AP.

In some examples, the hardware processor 406 dynamically sets a length of the expiration time to different values based on respective different conditions.

In some examples, the hardware processor 406 participates in an election process among a plurality of APs to elect one of the plurality of APs as the aggregator AP.

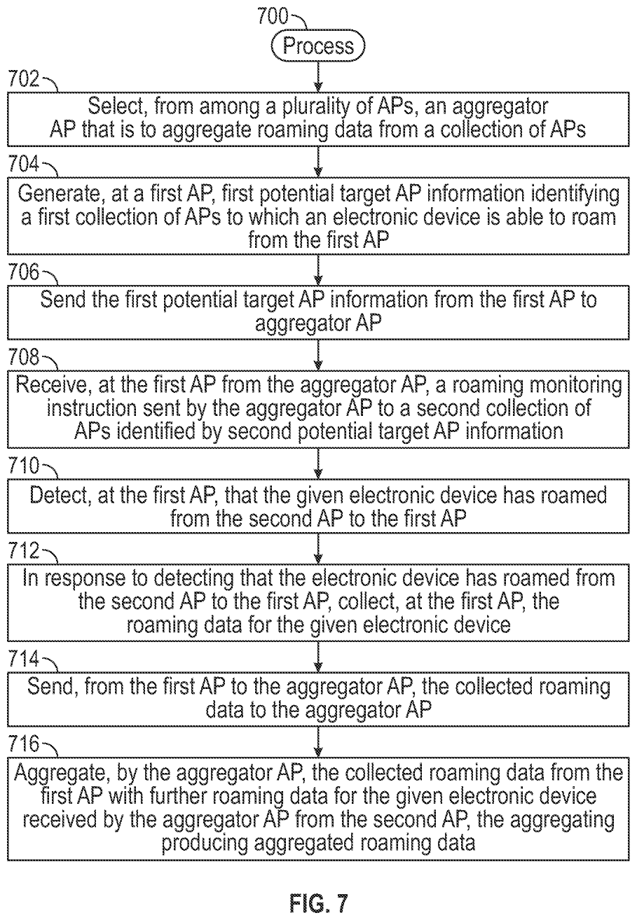

FIG. 7 is a flow diagram of a process 700 according to some examples. The process 700 includes selecting (at 702), from among a plurality of APs, an aggregator AP that is to aggregate roaming data from a collection of APs. The selection may be performed by the AP control system 106 (FIG. 1) or based on an election process among the collection of APs.

The process 700 includes generating (at 704), at a first AP, first potential target AP information (e.g., a first PFAP list) identifying a first collection of APs to which an electronic device is able to roam from the first AP.

The process 700 includes sending (at 706) the first potential target AP information from the first AP to the aggregator AP. For example, the first AP can send the first potential target AP to the aggregator AP when an electronic device associates with the first AP.

The process 700 includes receiving (at 708), at the first AP from the aggregator AP, a roaming monitoring instruction sent by the aggregator AP to a second collection of APs identified by second potential target AP information (e.g., a second PFAP list) generated at a second AP. The second potential target AP information identifies the second collection of APs to which an electronic device is able to roam from the second AP. The roaming monitoring instruction specifies the collection of roaming data for a given electronic device that has associated with the second AP.

The process 700 includes detecting (at 710), at the first AP, that the given electronic device has roamed from the second AP to the first AP. In response to detecting that the electronic device has roamed from the second AP to the first AP, the process 700 includes collecting (at 712), at the first AP, the roaming data for the given electronic device.

The process 700 includes sending (at 714), from the first AP to the aggregator AP, the collected roaming data to the aggregator AP. The process 700 includes aggregating (at 716), by the aggregator AP, the collected roaming data from the first AP with further roaming data for the given electronic device received by the aggregator AP from the second AP, the aggregating producing aggregated roaming data.

In some examples, the process 700 can include processing, at the aggregator AP, the aggregated roaming data to produce processed aggregated roaming data, and sending, from the aggregator AP to a remote server (e.g., the AP control system 106), the processed aggregated roaming data.

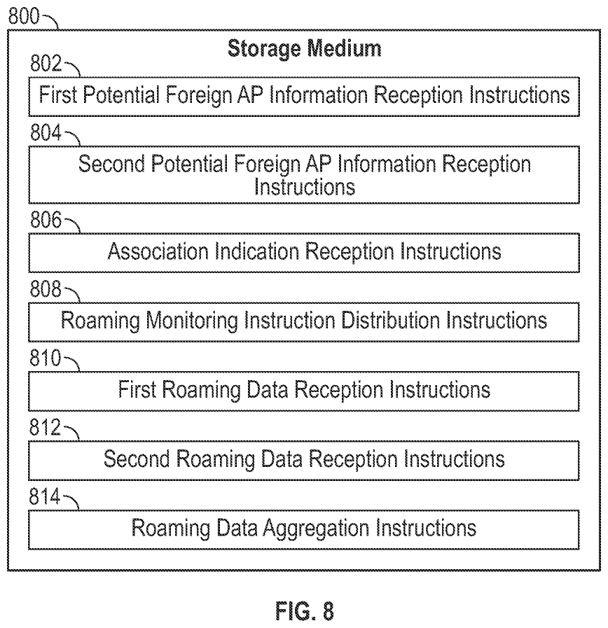

FIG. 8 is a block diagram of a non-transitory machine-readable or computer-readable storage medium 800 storing machine-readable instructions that upon execution cause an aggregator (AP) of a wireless network to perform various tasks.

The machine-readable instructions include first potential foreign AP information reception instructions 802 to receive, from a first AP, first potential foreign AP information identifying one or more APs to which an electronic device is able to roam from the first AP.

The machine-readable instructions include second potential foreign AP information reception instructions 804 to receive, from a second AP, second potential foreign AP information identifying one or more APs to which an electronic device is able to roam from the second AP.

The machine-readable instructions include association indication reception instructions 806 to receive, from the second AP, an association indication that a given electronic device has associated with the second AP.

The machine-readable instructions include roaming monitoring instruction distribution instructions 808 to, based on the indication that the given electronic device has associated with the second AP, send, from the aggregator AP to the one or more APs identified by the second potential foreign AP information, a roaming monitoring instruction specifying collection of roaming data for the given electronic device.

The machine-readable instructions include first roaming data reception instructions 810 to receive, at the aggregator AP from the first AP that is identified by the second potential foreign AP information, first roaming data collected by the first AP in response to the roaming monitoring instruction and roaming of the given electronic device to the first AP.

The machine-readable instructions include second roaming data reception instructions 812 to receive, at the aggregator AP from the second AP, second roaming data collected by the second AP responsive to the roaming of the given electronic device from the second AP to the first AP.

The machine-readable instructions include roaming data aggregation instructions 814 to aggregate, at the aggregator AP, the first roaming data and the second roaming data.

The storage medium 800 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A first access point (AP) comprising:
a wireless interface to communicate wirelessly with electronic devices; and
a hardware processor to:
generate first potential target AP information identifying one or more APs to which an electronic device is able to roam from the first AP;
send the first potential target AP information to an aggregator AP that is associated with the first AP; and
receive, from the aggregator AP, a roaming monitoring instruction sent by the aggregator AP to one or more APs identified by second potential target AP information generated at a second AP, the roaming monitoring instruction specifying collection of roaming data for a given electronic device that has associated with the second AP.

2. The first AP of claim 1, wherein the hardware processor is to:
detect that the given electronic device has roamed from the second AP to the first AP;
collect, based on the roaming monitoring instruction, the roaming data for the given electronic device at the first AP; and
send the collected roaming data to the aggregator AP for aggregation of the collected roaming data with further roaming data for the given electronic device received by the aggregator AP from the second AP.

3. The first AP of claim 1, wherein the hardware processor is to:
detect that the given electronic device has roamed from the first AP to a third AP;
determine that the third AP is not identified by the first potential target AP information; and
based on determining that the third AP is not identified by the first potential target AP information, update the first potential target AP information to identify the third AP.

4. The first AP of claim 1, wherein the hardware processor is to:
receive, from a service, first neighbor AP information derived from radio frequency (RF) information associated with a plurality of APs, the first neighbor AP information identifying neighbor APs of the first AP,
wherein the generating of the first potential target AP information comprises:
adding, to the first potential target AP information, identifiers of the neighbor APs from the first neighbor AP information, and
adding an identifier of a further AP based on an actual roaming event involving the further AP.

5. The first AP of claim 4, wherein the generating of the first potential target AP information comprises:
associating an indicator with the identifier of the further AP, the indicator indicating that the identifier of the further AP is related to the actual roaming event.

6. The first AP of claim 5, wherein the hardware processor is to:
receive, from the service, updated neighbor AP information identifying updated neighbor APs of the first AP; and
update, based on the updated neighbor AP information, the first potential target AP information to include the identifiers of the updated neighbor APs.

7. The first AP of claim 5, wherein the hardware processor is to:
update the first potential target AP information by removing an identifier of an AP that is in the first neighbor AP information and adding an identifier of another AP.

8. The first AP of claim 7, wherein the updating of the first potential target AP information comprises preventing a removal of the identifier of the further AP from the first potential target AP information based on presence of the indicator.

9. The first AP of claim 8, wherein the indicator has an expiration time, and wherein after the expiration time has elapsed the hardware processor is to clear the indicator.

10. The first AP of claim 9, wherein the hardware processor is to:
reset the expiration time based on detecting an electronic device roaming from the first AP to the further AP.

11. The first AP of claim 9, wherein the hardware processor is to:
dynamically set a length of the expiration time to different values based on respective different conditions.

12. The first AP of claim 1, wherein the hardware processor is to:
participate in an election process among a plurality of APs to elect one of the plurality of APs as the aggregator AP.

13. A method comprising:
selecting, from among a plurality of access points (APs), an aggregator AP that is to aggregate roaming data from a collection of APs;
generating, at a first AP, first potential target AP information identifying a first collection of APs to which an electronic device is able to roam from the first AP;
sending the first potential target AP information from the first AP to the aggregator AP;
receiving, at the first AP from the aggregator AP, a roaming monitoring instruction sent by the aggregator AP to a second collection of APs identified by second potential target AP information generated at a second AP, the second potential target AP information identifying the second collection of APs to which an electronic device is able to roam from the second AP, and the roaming monitoring instruction specifying collection of roaming data for a given electronic device that has associated with the second AP;
detecting, at the first AP, that the given electronic device has roamed from the second AP to the first AP;
collecting, at the first AP, the roaming data for the given electronic device;
sending, from the first AP to the aggregator AP, the collected roaming data to the aggregator AP; and
aggregating, by the aggregator AP, the collected roaming data from the first AP with further roaming data for the given electronic device received by the aggregator AP from the second AP, the aggregating producing aggregated roaming data.

14. The method of claim 13, further comprising:
processing, at the aggregator AP, the aggregated roaming data to produce processed aggregated roaming data; and
sending, from the aggregator AP to a remote server, the processed aggregated roaming data.

15. The method of claim 13, wherein the selecting of the aggregator AP from among the plurality of APs is performed by a remote service.

16. The method of claim 13, wherein the selecting of the aggregator AP from among the plurality of APs is based on an election process performed by the plurality of APs.

17. The method of claim 16, wherein the election process causes selection of the aggregator AP based on relative capabilities of the plurality of APs.

18. The method of claim 13, comprising:
detecting, at the first AP, that the given electronic device has roamed from the first AP to a third AP;
determine that the third AP is not identified by the first potential target AP information; and
based on determining that the third AP is not identified by the first potential target AP information, update the potential target AP information to identify the third AP.

19. A non-transitory machine-readable storage medium comprising instructions that upon execution cause an aggregator access point (AP) of a wireless network to:
receive, from a first AP, first potential foreign AP information identifying one or more APs to which an electronic device is able to roam from the first AP;
receive, from a second AP, second potential foreign AP information identifying one or more APs to which an electronic device is able to roam from the second AP;
receive, from the second AP, an indication that a given electronic device has associated with the second AP;
based on the indication that the given electronic device has associated with the second AP, send, from the aggregator AP to the one or more APs identified by the second potential foreign AP information, a roaming monitoring instruction specifying collection of roaming data for the given electronic device;
receive, at the aggregator AP from the first AP that is identified by the second potential foreign AP information, first roaming data collected by the first AP in response to the roaming monitoring instruction and roaming of the given electronic device to the first AP;
receive, at the aggregator AP from the second AP, second roaming data collected by the second AP responsive to the roaming of the given electronic device from the second AP to the first AP; and
aggregate, at the aggregator AP, the first roaming data and the second roaming data to produce aggregated roaming data.

20. The non-transitory machine-readable storage medium of claim 19, wherein the instructions upon execution cause the aggregator AP to:
process the aggregated roaming data to remove redundant information; and
send the processed aggregated roaming data to a remote server to analyze the processed aggregated roaming data.
